(19) United States
(12) Patent Application Publication
(10) Pub. No.: US 2017/0083183 A1
(43) Pub. Date: Mar. 23, 2017

(54) MULTIPLE RESOLUTION NON-LINEAR TERRAIN MAPPING SYSTEM

(71) Applicant: MapVision LLC, Rancho Mirage, CA (US)

(72) Inventor: Michael Malvin, Rancho Mirage, CA (US)

(21) Appl. No.: 15/265,797

(22) Filed: Sep. 14, 2016

Related U.S. Application Data
(60) Provisional application No. 62/220,882, filed on Sep. 18, 2015.

(51) Int. Cl. G06F 3/0482

(52) U.S. Cl. CPC G06F 3/0482; G06F 2203/04806; G06T 17/05

(57) ABSTRACT

A method and apparatus for creating non-linear maps that simultaneously displays multiple “defined areas of interest” on a map at different resolutions than the resolution of an underlying map is disclosed. A standard map, along with map layers containing the locations and data for domain-specific “areas of interest” are inputted. A Map Truth Table creates the key map coordinates that define the map areas that will be viewed in a higher resolution than the underlying map. This information is further processed to produce the final non-linear map output. Such a map could show, for example, local street-level details of areas with severe earthquake damage on a map covering 250,000 acres.

This application claims priority to U.S. Provisional Application No. 62/220,882, filed Sep. 18, 2015. This and all other extrinsic materials identified herein are incorporated by reference in their entirety.

### FIELD OF THE INVENTION

The field of the invention is non-linear map creation.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

With the advent of global positioning systems and the Internet, mapping has entered an enhanced era of functionality and value, such as linking precise location-specific data to maps. The prior art in mapping is extensive and sophisticated, for example Google® maps and Apple® maps.

However, the prior art does not adequately meet the need for map users to see the big picture of a situation while simultaneously seeing a closer view of multiple domain-specific areas.

In the example Scenario, there is a major earthquake in the San Diego, Calif. area. There are twelve areas of major damage and the Disaster Response Team is trying to assess the locations and extent of damage to assist in their planning efforts.

Standard maps of an Earthquake Area might show the San Diego, Calif. region in a map area of twenty miles by sixteen miles. The twelve major earthquake damage locations could be shown on such a map, but they would likely overlap each other on a Map, because the Map covers such a large geographic area.

Among other deficiencies, maps do not provide actionable details, at useful resolutions, about the exact locations of major damage. The prior art does not provide a means for human integration of high level visual data, in one place at one time.

There is an unmet need for a method and system that addresses these and other deficiencies in the prior art. The present invention is directed toward providing such a technique.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems, and methods to generate a map view from a map area.

FIG. 8 shows a non-limiting overview of a prior art input that is used to produce an inventive output of the present invention. FIG. 9 shows a non-limiting comparison of a prior art terrain map of the San Diego Earthquake Area as compared to a novel, inventive non-linear terrain map of the San Diego Earthquake Area based on an embodiment of the present invention.

As used herein, a “map area” is a 2-D or 3-D area of a map that is received from a device, such as a server that provides maps (e.g. a Google™ map server), a scanner, or some other map repository. The system could be configured to retrieve such a map area in any suitable manner, for example by allowing a user to select the map area and import it into the system or by automatically importing the map area as part of a search. In some embodiments, the system allows a user to enter a search for a map area containing areas of interest, such as directions from one location to another location (which provides a map area having turn-by-turn directions as areas of interest) or a fire hazard map (which provides a map area having fire hazard spots as areas of interest).

The system generally has an interest module which defines an interest metric that varies as a function of a location in the map area. As used herein, an “interest metric” is a quantifiable metric that indicates the level of interest in a location in the map area. The interest metric could be selected by a user of the system, for example a user could define the interest metric, or the system could provide a list of potential metrics for the user to select. Contemplated metrics include a turn in a route map, a length of a non-turning segment in a route map, a Richter scale measurement, a temperature, an elevation, and an alert. In some embodiments, the interest metric could be measured on a sliding scale, such as an interest metric for an earthquake measurement on a Richter scale, and in other embodiments the interest metric could be a binary value, such as a “true” for a non-turning segment in a route map and a “false” for an area of a route map without a non-turning segment. In some embodiments, the system could calculate the interest metric's binary value as a function of a measured value as compared to a threshold, for example the system could indicate that an earthquake measurement has a “true” measurement (indicating that it's an area of interest) when a Richter scale measurement is above 5, and has a “false” measurement (indicating that the measurement is not an area of interest) when a Richter scale measurement is 5 or below.

The system also has an AOI (Area of Interest) module that defines multiple areas to expand in the map area as a function of the interest metric. In some embodiments, the areas could be defined by a user through a user interface. In such embodiments, the system could present a representation of the interest metric in the map area to an output user interface (for example by displaying the map area on the screen with dots indicating the areas of interest). The user could then mark off the borders of areas to expand by selecting portions of the map area on the screen. In other embodiments, the AOI module could be configured to define a set of areas in the map area automatically, such as, for example, by extrapolating rectangles between two turns in a turn-by-turned map, or by automatically drawing an area as a function of two areas to expand.

The AOI module is also preferably configured to calculate a collective interest density of each area in the set of areas. A collective interest density of an area can be calculated by summing up the total value for all interest metrics within the area, and dividing that value by the area (or volume for a 3-D map area). In some embodiments, the AOI module is configured to rank each area of the set of areas by its collective interest density, and automatically select the most dense areas of the set of areas as a function of their comparative collective interest metric density. In some embodiments, a user interface could be provided that allows a user to select the number of areas to expand, such as 2, 3, 5, 8, 10, or more. Preferably, the selected areas to expand are non-overlapping with one another. In other embodiments, the AOI module could be configured to resize the area to expand to increase the collective interest metric density for the area, for example by expanding the area to include another area of interest or by contracting the area such that a border of the area is closer to an area of interest. The AOI module could be configured to reiteratively resize each area until a standard deviation of an original collective interest metric density for the old area and a resized collective interest metric density for a new area falls below a threshold value. For example, if the resized version has a resized collective interest metric density that is only 0.01 larger than the original collective interest metric density, the system could be configured to stop reiteratively optimizing the area to expand.

In some embodiments, the system could have a triggering module that transmits alerts to distal entities as a function of each area and its collective interest density. For example, the system could divide the map into pre-defined areas, such as electronic grids or alert districts. A given map area might have a number of electronic grids, such as 12 electronic grids, where each electronic grid can be controlled by an activation switch and a shut down switch. The triggering module would then transmit alerts for each electronic grid area that has a collective interest metric over a given threshold, such as 5 or 10 or 20 or more. As an example, the system could be configured to calculate the collective interest metric of a number of fires in each electronic grid on a map, and transmit an alert to a distal control room to deactivate the electricity in electronic grid areas having a collective interest metric of over 5 fire alerts per 50 acres. In response, the control room could deactivate the electricity in those grid areas. Or the system could be configured to calculate the collective interest metric of a peak Richter scale measurement in different alert areas, and transmit an alert to alert districts having a peak Richter scale measurement of over 7.5. The alert district could then broadcast alerts, such as a radio message or speaker message, that is transmitted across the entire area to notify people in that area where they should head for safety reasons.

An expanded view module preferably defines dimensions for each of the areas to expand, to create zoomed-in views of those areas. The expanded view module could be configured to define the sets of dimensions through a user interface that receives a user's input regarding how large each area to expand should be zoomed in to. Or the expanded view module could be configured to automatically define the sets of dimensions, for example by multiplying the dimensions by a factor of 2, 3, 4, or any suitable number, by selecting the dimensions as a function of the area's collective interest metric, or by defining the dimensions as a function of the size of the map area as compared to the size of the area to expand. In some embodiments, the expanded view module could be configured to rotate the zoomed-in view to accommodate spacing requirements in the map area.

Once the system understands what areas to expand and how large to expand the areas, a map generator generates an overall view of the map area with the constructed overlaid zoomed-in views over the overall view. This allows a user to see a single map having multiple zoomed-in views that highlight the areas of interest, without having to look at multiple pages of maps. The overlaid zoomed-in view could be overlaid over the areas to expand or could be placed to the side of the areas to expand. For example, the map generator could be configured to ensure that the zoomed-in view is not overlaid over an area of interest, or does not cover an area having a collective interest metric above a given threshold. In some embodiments, the overlaid zoomed-in view could be overlaid in a manner to match a corner of the area to expand. Preferably, the map generator is also configured to ensure that the overlaid zoomed-in views are not overlaid over one another.

In this manner, the system constructs an overall view of a map having various zoomed-in views highlighting areas having large clusters of areas of interest. Various objects, features, aspects and advantages of the inventive subject matter will become more apparent from the following detailed description of preferred embodiments, along with the accompanying drawing figures in which like numerals represent like components.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

A clear understanding of the key features of the invention may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating.

FIG. 1 Block Hardware Diagram

FIG. 8 Shows an exemplary input and output of an inventive system

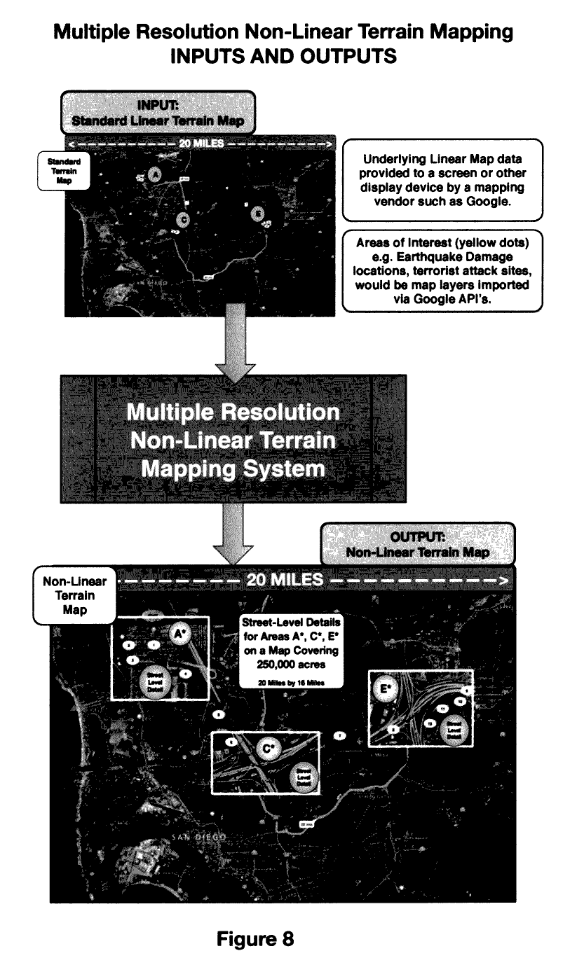

FIG. 9 Example of Standard and Non-Linear Terrain Maps

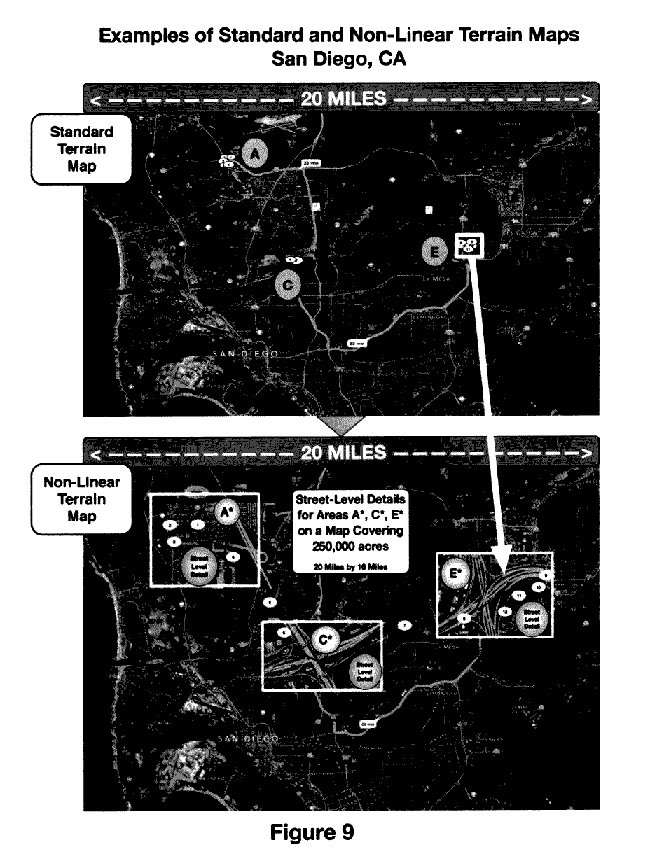

FIG. 10 Non-Linear Terrain Mapping 100

FIG. 11 User Input Interface 102

FIG. 11-1 Non-limiting Examples of Control Vectors

FIG. 11-1A Non-limiting Examples Pre-Loaded Control Vectors

FIG. 12 Internal Representation Module 106

FIG. 13 Map Transformation Truth Table Module 108

FIG. 14.1 Microsoft Excel Program for Map Truth Table—Columns A-G

FIG. 14.2 Microsoft Excel Program for Map Truth Table—Columns H-J

FIG. 15 Linear Map Segment Coordinates 110

FIG. 15-1 Linear Map Segment Coordinates 110 Plotting Routine

FIG. 16 Linear Map Segment Area Definitions 112

FIG. 16-1 Linear Map Segment Areas 112 Plotting Routine

FIG. 16-2 Non-Limiting Example of Map Segment Areas 112

FIG. 16-3 Microsoft Excel Program for Calculating Map Areas 112

FIG. 17 Non-Linear Linear Map Area Definitions 114

FIG. 17-1 Autonomous Derivation of Non-Linear Map Areas

FIG. 18 Populating Non-Linear Map Areas With Data 116

FIG. 19 Non-Linear Terrain Map 116

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The present invention provides a method and apparatus for creating non-linear maps that simultaneously displays multiple defined “areas of interest” on a map, at different resolutions than the resolution of the underlying map. The software, physical machine hardware, firmware, communications protocols and methods may be collectively referred to as system.

The non-limiting example below illustrates some of the principles of the present invention and its utility and value compared to the prior art. The example Scenario involves the use of the present invention in an Earthquake Disaster Response situation.

An object of the present invention is to allow for the simultaneous display of multiple map areas at different resolutions, at the same time on the same map. A further object of the present invention is to avoid the need for scrolling, gesturing, clicking or shuffling through printouts to see all the information in one place at one time. Further advantages, as well other non-limiting embodiments of the present invention are enumerated in this disclosure.

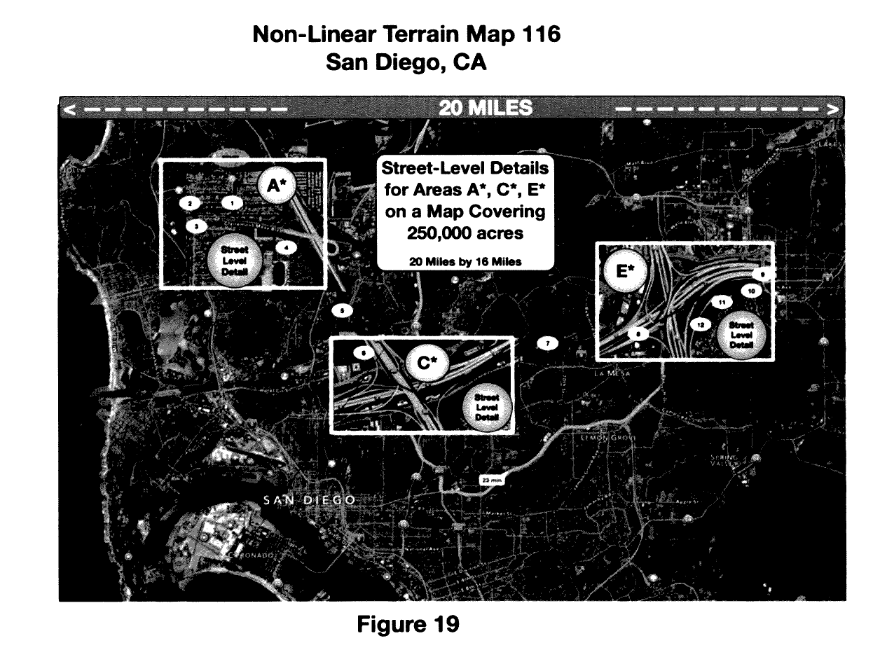

FIG. 19 is a non-limiting exemplary embodiment of a non-linear terrain map, based on the apparatus and methods of the present invention

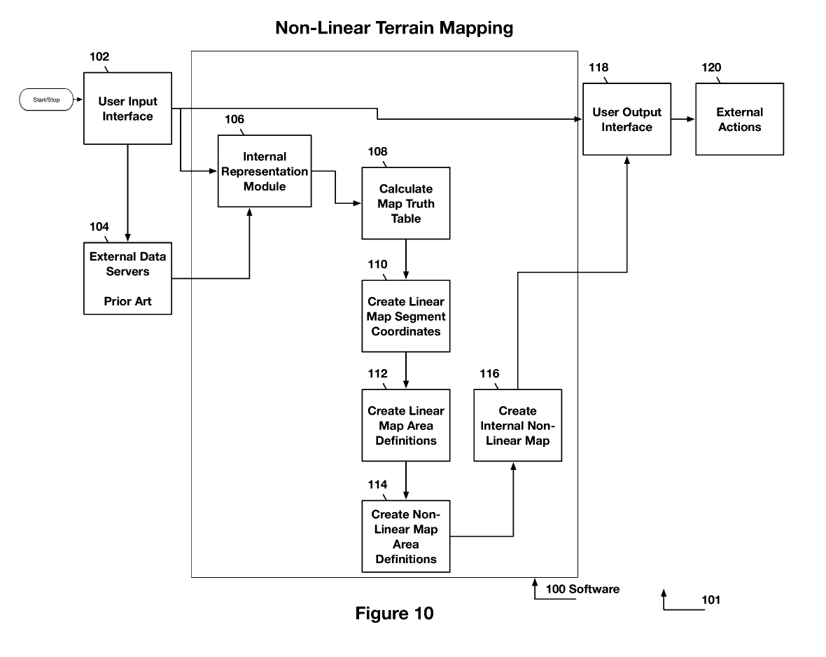

Referencing FIG. 10, a User Input Interface 102 allows the user to specify the External Data Servers 104 that are to be accessed; define the data to be requested from each External Data Server and provide Control Parameters to control the Internal Representation Module 106. In a non-limiting example, the External Data Servers 104 could have, for example, a Google® map server, and/or a FEMA real time earthquake database server.

Control Parameters are provided by the User Interface Module 102 to the External Data Servers 104, and the Internal Representation Module 106. In this example, Control Parameters would include but are not limited to: the Map Scale, the longitude and latitude of the four points defining the corners of a desired rectangular map, and a Richter Scale Control Parameter of 5.0.

The data requested from the External Servers 104 is provided to the Internal Representation Module 106 and would typically include standard data and graphics available under prior art, such as Google or Apple.

Additionally, in this example, the Internal Representation Module 106 would use the FEMA server data to determine the longitude and latitude Coordinates of the twelve locations in the Map that the FEMA database identified as exceeding the Richter Scale Control Parameter of 5.0. These twelve points are referred to as a Domain-Specific Areas of Interest Definition, or Area of Interest or AOI. The Area of Interest can be large or it can be a point.

A prior art map could show map data overlaid with the location of the twelve severe earthquake damage zones. In addition to the data visible on the map, the Internal Representation Module (IRM) 106 could contain additional information such as the X,Y (Longitude and Latitude) Coordinates of each Area of Interest (AOI) which in turn is driven by the given Control Parameters. In Map B FIG. 10, the twelve AOI's are the areas where the Richter scale earthquake strength was greater than 5.0. It is simple to compute the distance between any two points using the Pythagorean Theorem.

The Internal Representation Module passes its information (the IRM Data) to a Map Truth Table 108. The Map Truth Table 108 takes the IRM Data and dynamically defines Map Segment Coordinates 110 as a function of the current Areas of Interest. Different Area of Interest definitions in the Control Parameters will automatically and dynamically produce different Map Segments Coordinates.

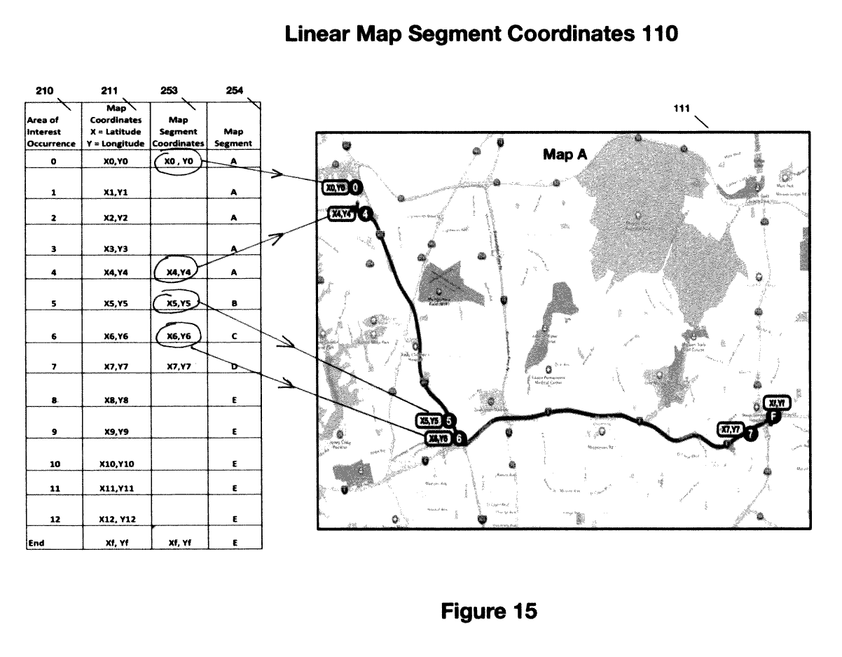

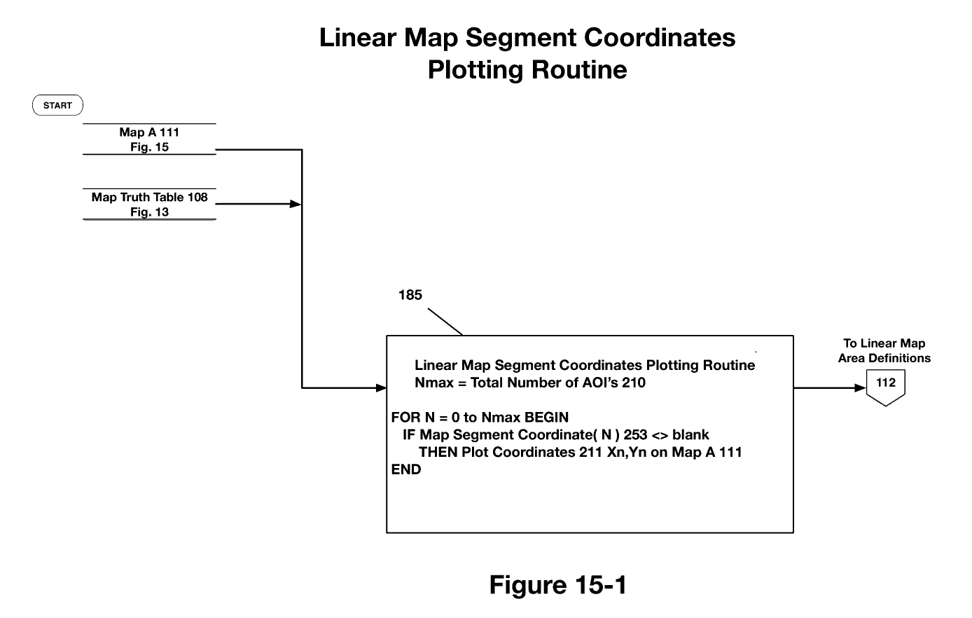

As a non-limiting example, the Map Truth Table 108, applied to a Map, and based on the San Diego Earthquake Scenario, would produce the following Linear Map Segment Coordinates 110 (X0,Y0), (X4,Y4), (X5,Y5), (X6,Y6), (X7,Y7), (XF,YF) in Map C, FIG. 15,

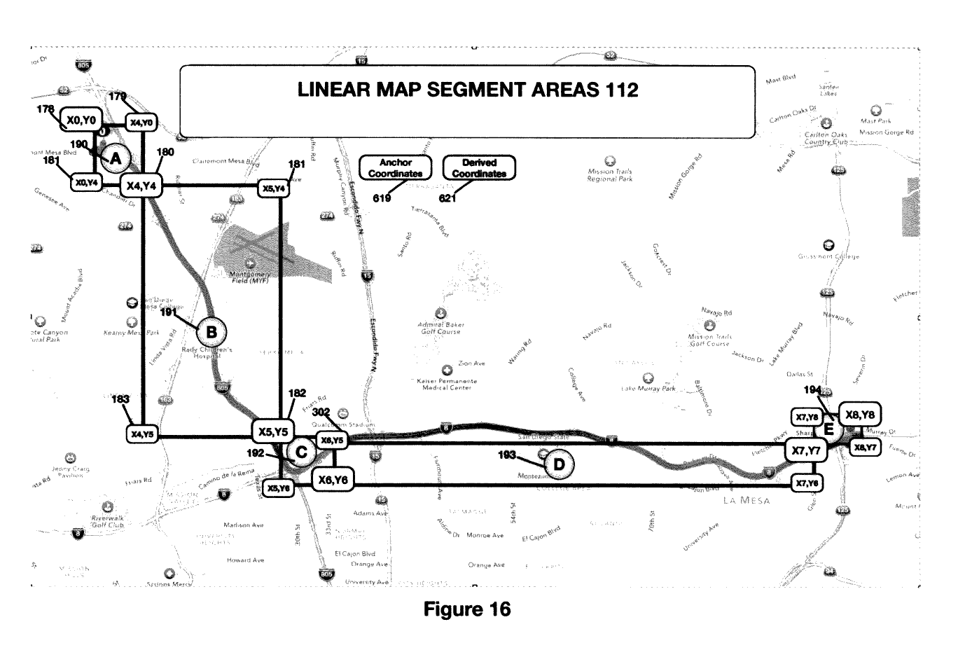

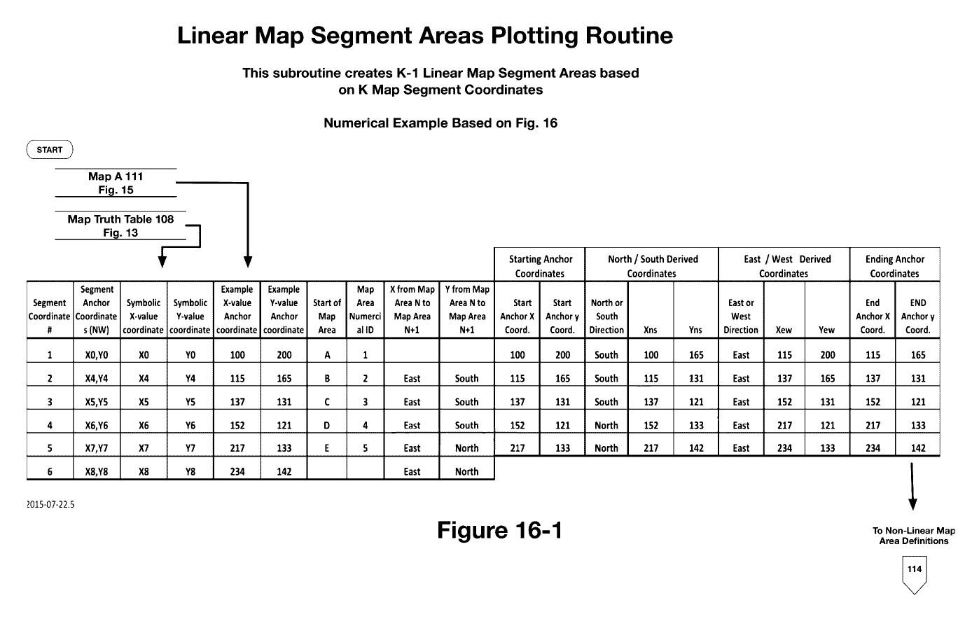

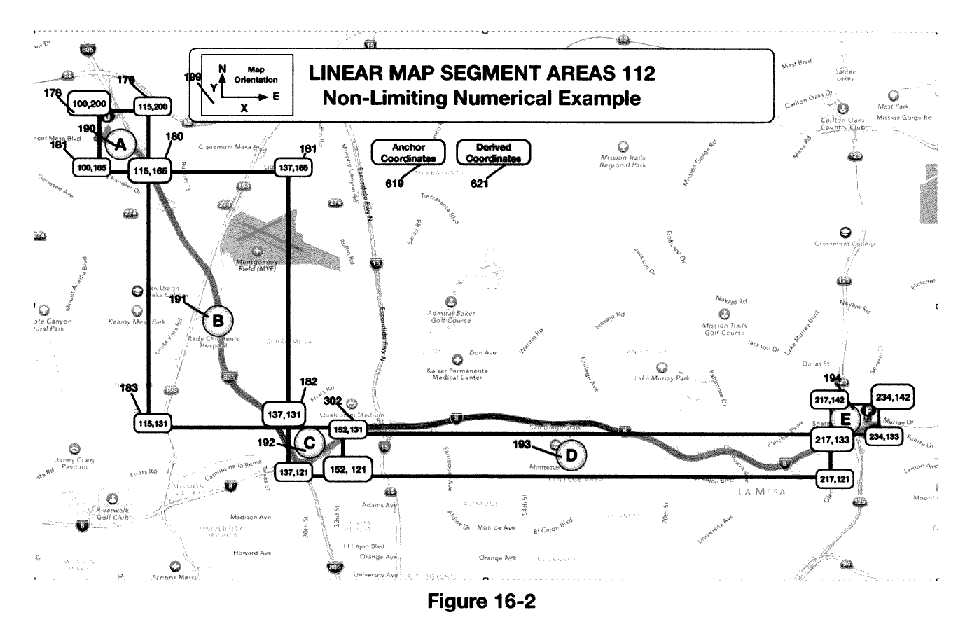

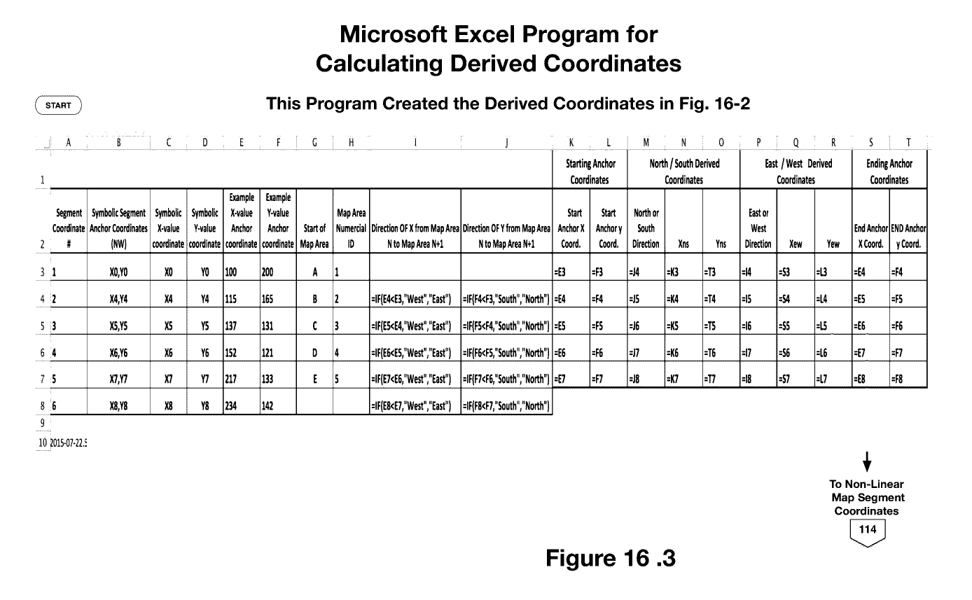

The Linear Map Area Definitions 112 shown in FIG. 16 uses the data from the Map Segment Coordinates Module 110 FIG. 15 to create defined rectangular map segments. In other embodiments of the invention, the Map Segment Areas may be other shapes. In this illustrative embodiment, the Map Segment Areas are calculated by “squaring off” each successive pair of Map Segment Coordinates, as shown in FIG. 16.

FIG. 16-2 is a non-limiting numerical example showing the four corner X,Y Coordinates for each of the Linear Map Segment Areas. For example, Map Segment A 190, has Coordinates 178, 179, 180 and 181 for its four corners.

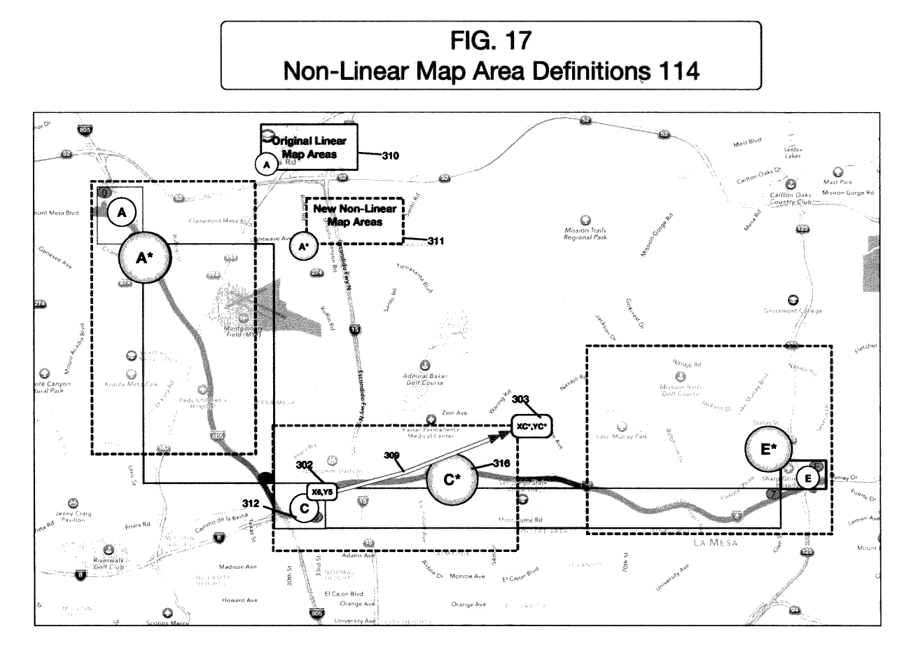

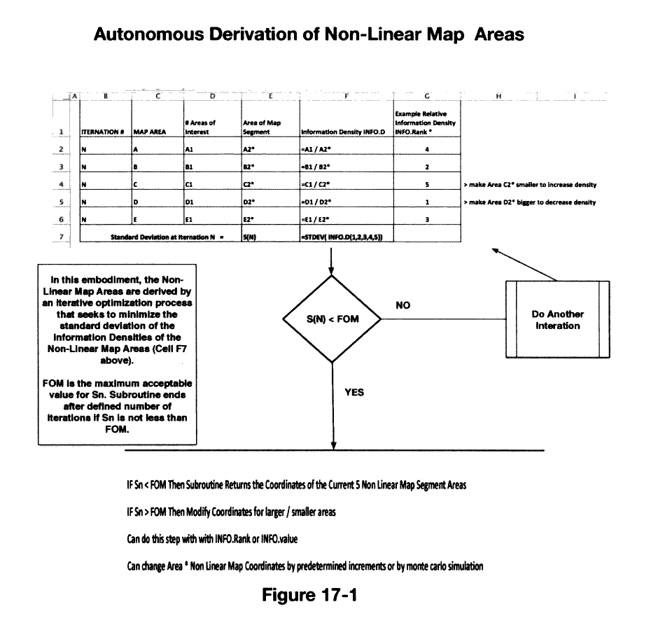

With reference to FIG. 17, the Non-Linear Map Area Definitions Module 114 receives the data from the Linear Map Area Definitions Module 112. In this non-limiting illustrative example, the Linear Map Area Definitions 114 are rectangles A, C and E.

Based on Control Parameters received from the User Input Interface Module 102, the Non-Linear Map Area Definitions Module 114, operates on the Linear Map Areas 112 in FIG. 16, to produce a mapping of the Original Linear Map Segment Areas A, C, E, 310 into the Non-Linear Map Segment Areas A*, B*, C* 311.

In a non-limiting exemplary embodiment displayed in FIG. 17, the mapping C→C* of Linear Area C into Non-Linear Area C* is accomplished by selecting, using exemplary devices such as touch screens or a mouse, Point 302 (coordinates X6,Y5) and dragging the pointer to Point 303 (coordinates XC*,YC*). This action defines the new Non-Linear Area C*. The mapping A→A* and the mapping E→E* are accomplished by the same process.

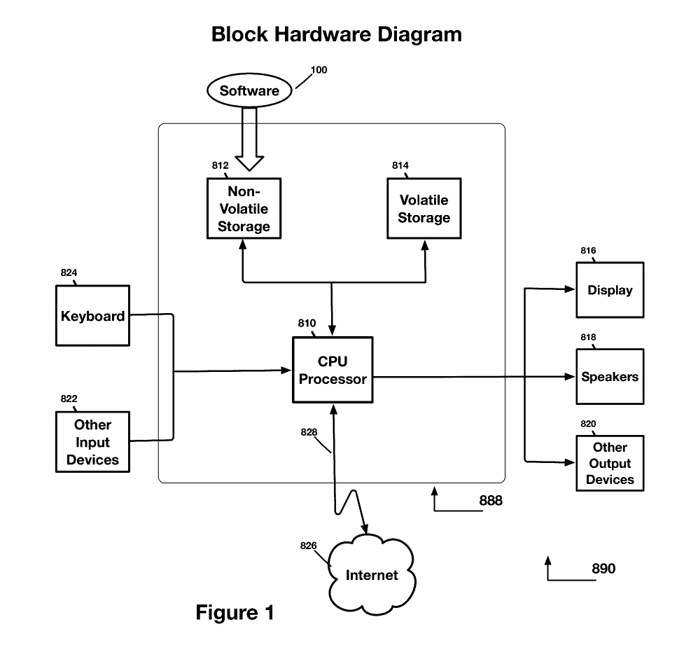

In yet another non-limiting exemplary embodiment, FIG. 17-1 discloses a method for the Autonomous Derivation of Non-Linear Map Areas 311 from Linear Map Areas 310. In this embodiment, the coordinates of Linear Map Areas 310 are modified in a series of sequential iterative optimizations to determine Non-Linear Map Areas 311 that have equal information densities. In this example, the Information Density of a proposed C* Non-Linear Map Area 316 would be defined as the [Number of AOI's in C*]/[Area of C*]. A set of final coordinates A*, B*, C* is determined when the standard deviation of the Information Densities for A*, B*, C* is less than a defined threshold or a maximum number of iterations has occurred.

The two foregoing non-limiting exemplary embodiments for mapping from Linear→Non-Linear Map Areas show two completely different methods for accomplishing a Linear to Non-Linear Map Transform. Accordingly, a person having ordinary skills in the art can readily see that the present invention is not limited in scope to any particular type of devices, methodologies, criteria and rules for the Map Transform process, which may be of any type or design. Additionally, the scope of the invention is not limited by the devices, media or systems on which information is gathered, computed or transmitted

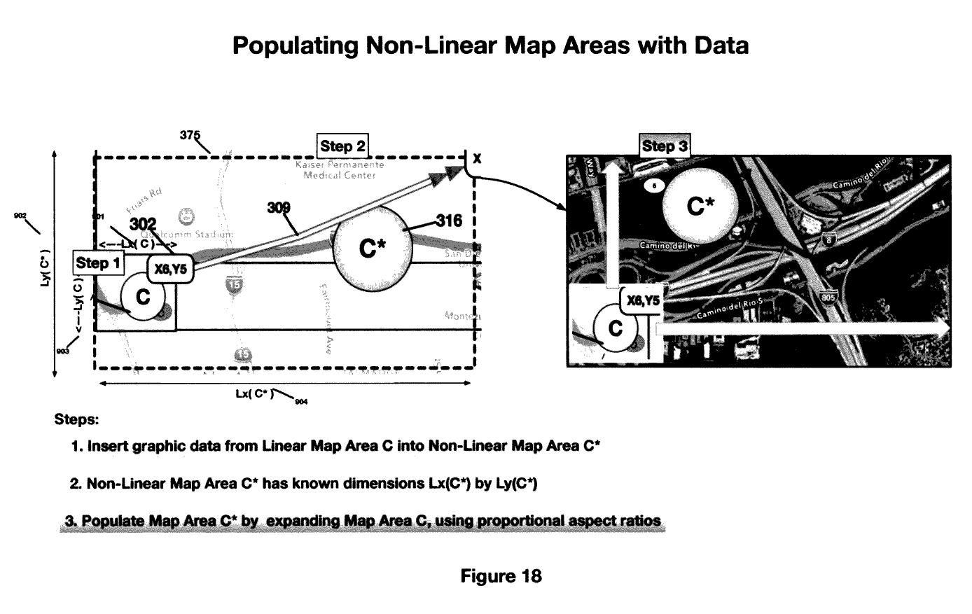

At this point, the Non-Linear Map Areas 311 A*,B*,C* exist as three rectangles, each with four Coordinates. FIG. 18 explains how the Non-Linear Map Areas 311 A*, B*, C* are populated with non-linear map data, for assembly into the final internal Non-Linear Map 116. At this point, the size and coordinates of A*, B*, C* are known but there is no actual non-linear map data within any of the non-linear rectangles.

In a non-limiting example, as shown in FIG. 18, the Internal Non-Linear Map Module 116 takes the Areas of Interest C 312 at its original scale, as in FIG. 17, and inserts it into the rectangle containing the Non-Linear Map Segment Area C* 316 in FIG. 17. The original Map Area C is expanded in proportion to the aspect ratio and size of C and C*. Other embodiments of the present invention could, by way of a non-limiting example include scaling, rotation or cropping of image.

The data from the Internal Non-Linear Map Module 116 is directed to the User Output Interface Module 118. Additionally, Control Parameters from the User Input Interface 102 are directed to the User Output Interface 118. The User Output Interface Module 118 uses the Non-Linear Map Data and the specified Control Parameters to create an Externally Presented Non-Linear Map 120, configured to be presented on one or more external devices or media specified by the Control Parameters. A non-limiting example of such a Map 120 is shown in FIG. 19.

In other non-limiting embodiments, the Externally Presented Non-Linear Map 120 could be presented on a video monitor, as a PDF or JPG file, on a smart phone or on a virtual reality device. In a further non-limiting example, the Areas of Interest could be street turns on a driving map. In another non-limiting example, the Data Servers could be the National Oceanic and Atmospheric Administration (NOAA) public data servers, or the State of Louisiana oil spill database. In another non-limiting example, the Map Domain area could be a portion of the sky containing 100 million galaxies and the Areas of Interest could be regions emitting quasar energy above a given frequency.

A person having ordinary skills in the art can readily see that the present invention is not limited in scope to any particular type of data, Data Servers, Data Domains, Data Requests or Control Parameters. Additionally, the scope of the invention is not limited by the devices, media or systems on which information is gathered, computed, processed, transmitted or displayed, or by the nature of such information, or upon whether the information is gathered, computed, processed, transmitted or displayed in static mode, updated intermittently, or updated in real time.

For purposes of describing an exemplary embodiment of the invention, reference will be made to the figures set forth above. With reference to FIG. 1, in a presently preferred embodiment, the hardware platform includes a CPU/Processor 810, persistent Non-Volatile Storage 812, Volatile Storage 814, Input Devices 822 and 824, Output Devices 816, 818 and 820, and a Network Connection 810 to the Internet 826. A specific example of a suitable hardware platform is an Apple Computer iMac Retina with a 3.3 GHz Intel Core i5 processor, 8 GB 1600 MHz DDR3 memory and a 1 TB disk drive, connected to the Internet via a Verizon Fios network connection, running OS-X Yosemite, but it is to be understood that the teachings herein can be modified for other presently known or future hardware platforms. The software 100, described below, based on the Flowchart shown in FIG. 10, is stored in the Non-Volatile Storage 812, and runs in on CPU 810 at runtime, making use of the Volatile Storage 814 as needed.

With reference to FIG. 10, there is shown a system 101 of an exemplary embodiment of the present invention. The system 101 includes Software 100, a User Interface 102, External Data Servers 104, an Internal Representation Module 106, a Map Truth Table 108, a Linear Map Segment Coordinates Module 110, a Linear Map Area Definitions Module 112, a Non-Linear Map Area Definitions Module 114, an Internal Non-Linear Map Module 116, a User Output Interface 118, and an Externally Presented Non-Linear Map 120.

It will be understood by those in the art and by a description of several non-limiting embodiments herein that the components comprising the system 101 are not necessarily independent stand-alone components and may, in fact, be functions within a single component. The User Input Interface 102 receives input via keypad, touch screen, mouse, voice or any other kind of known or future input mechanism and may include a display screen.

The External Data Servers 104 are exemplary servers that provide Map Data, and data streams pertaining to the Domain-Specific-Areas-Of-Interest of any particular embodiment of the invention. The non-limiting examples below illustrate alternative embodiments.

| | DOMAIN-SPECIFIC- |
|---|---|
| MAP DATA | AREAS-OF-INTEREST |
| A Land Map of the San Diego, CA region | Locations with earthquake |
| | Richter Scale reading |
| | greater than 5.0 |
| A Land Map of the San Diego, CA region | Driving directions between |
| | two street addresses |
| A Map of the Waters of the | Areas with oil spills |
| Gulf of Mexico | |
| An Astronomy Map of a portion | Isophotal magnitude of |
| of the universe | galaxies with surface |
| | brightness <25 mag/arsec² |

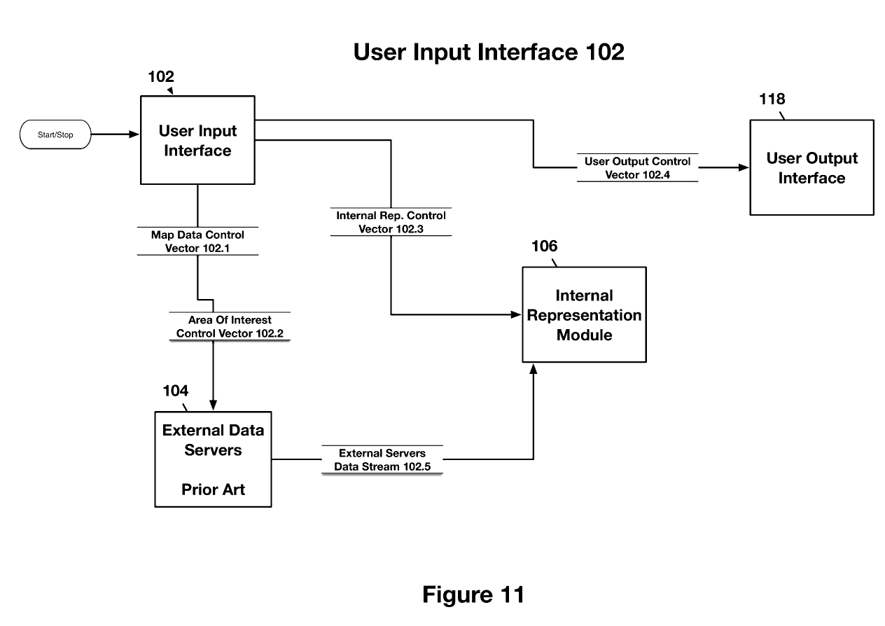

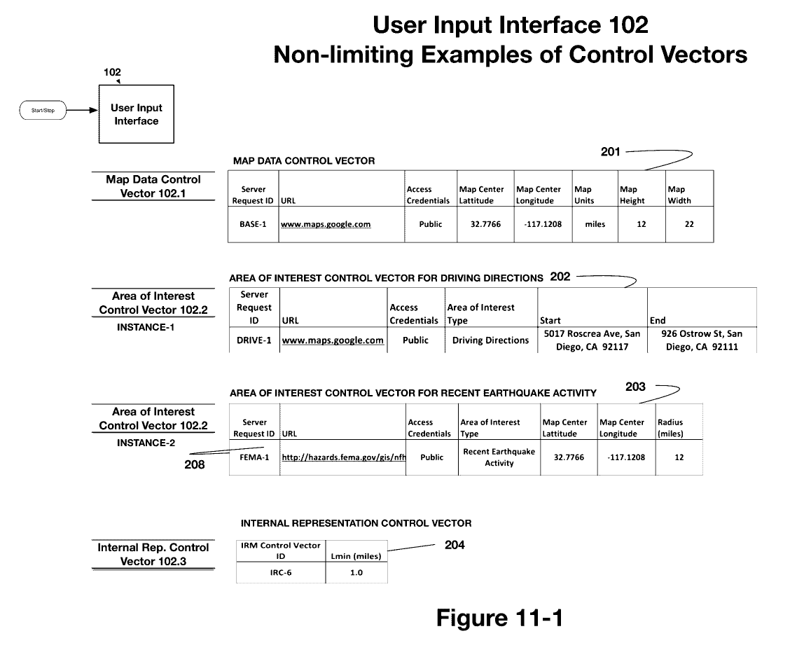

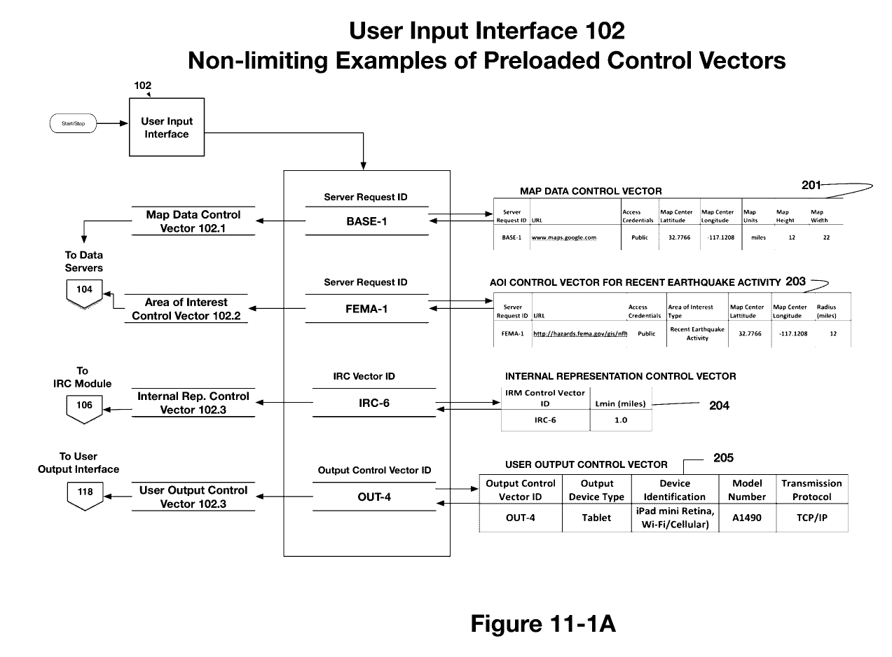

Turning now to FIG. 11, there is a more detailed description of the User Input Interface (U/I) 102. The U/I provides controls, input variables and parameters to various portions of the system via four Control Vectors. More specifically, The U/I 102 provides the Map Data Control Vector 102.1 and the Domain-Specific-Areas-Of-Interest (AOI) Control Vector 102.2 to the External Data Servers 104. The Map Data Control Vector 102.1 and the AOI Control Vector 102.2 may be contained in one, or two separate vectors and be directed at one or more External Servers. The U/I 102 also provides an Internal Representation Module [IRM] Control Vector 102.3 to the Internal Representation Module (IRM) 106, and an Output Control Vector 102.4 to the User Output Interface 118.

The Control Vectors may be linear vectors or matrix arrays. The number of elements and the definition and content of each element of a Control Vector will vary with each embodiment or instance of the invention. Each elements of a Control Vector may be of a different type, for non-limiting examples: a number, a formula, a picture, an Internet address, a file.

Refer to FIG. 11-1 for non-limiting illustrative example of Control Vectors. The first element of any instance of a Control Vector contains an Instance Identifier. For example, in the Area of Interest Control Vector Instance 2 203, the Instance Identifier 208 is “FEMA-1”.

FIG. 11-1 shows two Area of Interest Control Vectors 102.2. Instance-1 202 for Driving Directions and Instance-2 203 for Recent Earthquake activity. Although these two Instances are both Area of Interest Control Vectors 102.2, each Control Vector Instance contains a different number of elements, data and element types, demonstrating the content-independent general applicability of the present invention.

A person having ordinary skills in the art can readily see that the present invention is not limited in scope to any particular type of data, Map Data, Data Servers, Data Server Information Requests, Domain-Specific-Areas-of-Interest, or the nature or type of any Data Requests or Control Parameters, or the format, definition, design or content of Control Parameter Vectors.

In another illustrative embodiment as shown in FIG. 11-1A, some or all of the Control Vectors may pre-loaded into the User Input Interface 102 so that Control Vector specifications can be saved for future use and can be selected by a simple identifier.

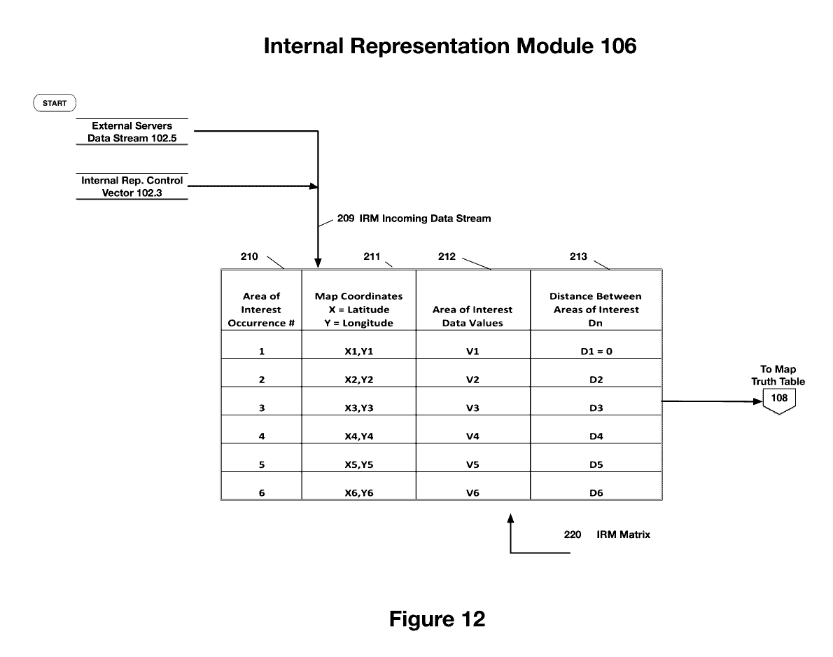

Referencing FIG. 12, the External Servers Data Stream 102.5, and The IRM Control Vector 102.3 the are passed to the Internal Representation Module (IRM) 106 by the IRM Incoming Data Stream 209.

The IRM 106 has as inputs the External Servers Data Stream 102.5 and the IRM Control Vector 102.3. The output of the IRM 106 provides input to the Map Truth Module 108. With reference to FIG. 12, a purpose of the IRM 106 is to transform portions of the IRM Data Stream 209 into the matrix array IRM Matrix 220 which is passed to the Map Truth Table 108. The Area of Interest Occurrence #210 indexes the occurrence number. The Map Coordinates 211 contain the Latitude and Longitude of the AOI occurrence. The Area of Interest Data Values 212 contain data related to the particular Occurrence #210. Area of Interest Occurrences 210 are declared if the Area Of Interest Data Values data point satisfies satisfy a defined condition. Finally, the Distance Between Areas of Interest (Dn) 213 may be calculated from the Map Coordinates 211 using the Pythagorean Theorem, or the Dn values may be provided as part of the IRM Incoming Data Stream 209.

In a non-limiting example, an Area of Interest Occurrence 210 would be declared if the Richter Scale 212 earthquake reading was greater than 5.0. In another non-limiting example, the Area of Interest Occurrences 210 would be declared where turns occurred in a driving map and the Distance Between Turns 213 was less than one mile. In other illustrative embodiments the Area of Interest Data Values 212 may be calculated and displayed in the Map Truth Table Module 108 rather than in IRM 106.

A person having ordinary skills in the art can readily see that the present invention is not limited in scope to any particular type of Map Coordinates 211 or Area of Interest Data Values 212. In non-limiting examples, the Map Coordinates could be the (x,y) coordinates of the distance from a military base, or the Map Coordinates 211 could be the conventional earth-based longitude and latitude coordinates (x,y). In a further non-limiting example, the Area of Interest Data Values 212 could be the Richter Scale Earthquake value at a particular Area of Interest Occurrence 210, or the Distance Since the Last Turn on a map of driving directions.

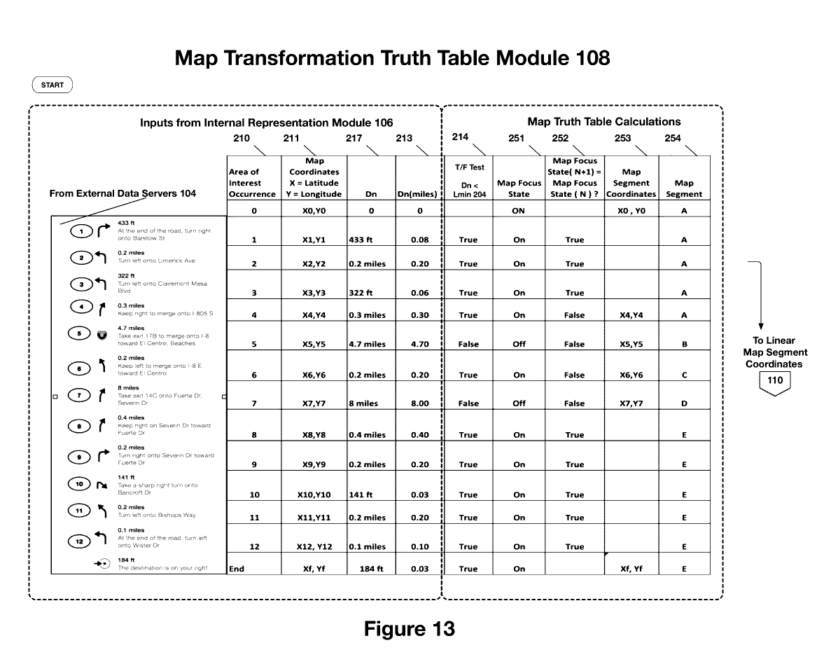

Referring now to FIG. 13, the Map Truth Table Module 108 receives input from the Internal Representation Module 106 and performs a series of logic calculations. The output of the Map Truth Table Module 108 is a vector of Map Segments 254. In the non-limiting example of FIG. 13, the twelve Area of Interest Occurrences 210 are non-linearly mapped into five Map Segments 254 A,B,C,D,E.

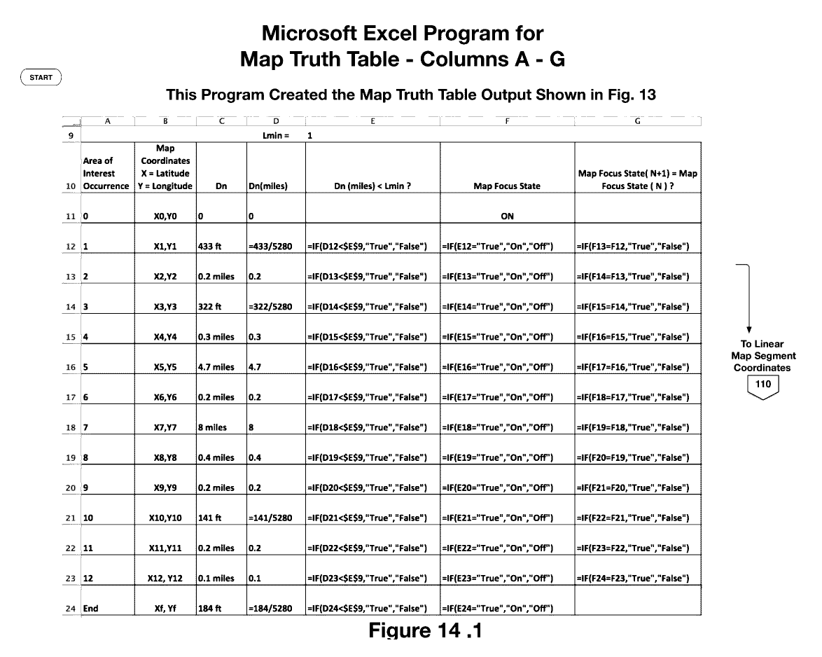

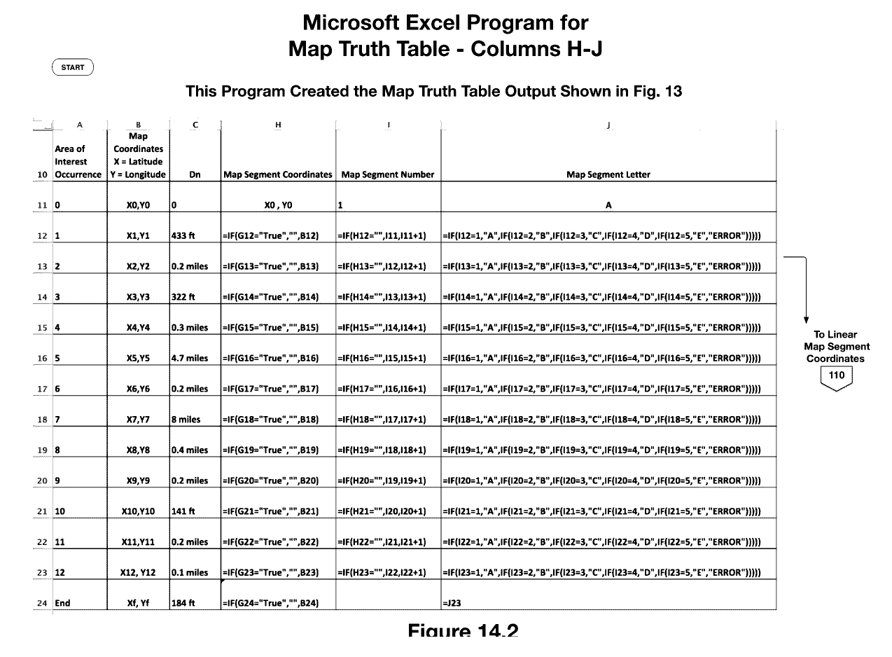

The logic and detailed computational methodology underlying the Map Truth Table Calculations 251, 252, 253, 254 are fully disclosed in FIG. 14-1 “Microsoft Excel Program for Map Truth Table Columns A-G”, and in FIG. 14-2 “Microsoft Excel Program for Map Truth Table Columns H-J”.

In the non-limiting example of FIG. 13, for a given AOI(n) 210, if Dn 213<Lmin 204, the value in T/F Test 214 is set to TRUE, otherwise FALSE. In the non-limiting example in FIG. 11-1, Lmin 204 is passed to the Map Truth Table 108 from Internal Rep. Control Vector 102.2 shown in FIG. 11-1. A person skilled in the art can readily see that the present invention is not limited in scope by any particular definition of the T/F Test 214 or by the test value Lmin 204. In non-limiting examples Dn 213 could be the distance to the next turn, or the distance to the nearest star, or a Richter Scale earthquake value; Lmin could be 1.0 miles, 10 light-years, or a Richter Scale value of 5.0.

The Map Focus State 251 is set to ON if T/F Test 214 is TRUE, otherwise 251 is set to FALSE.

In the non-limiting example of FIG. 13 The Map Focus Logic 252 is calculated as follows: If the Map Focus State 251 of AOI(n+1) equals the Map Focus State 251 of AOI(n) then the Map Focus Logic(n) 252 is set to TRUE, else FALSE.

AOI(0) 210 is the initialization row of the Truth Table. The Coordinates of AOI(0) 253 are set to X0,Y0. In a non-limiting example X0,Y0 could be the upper left hand corner of a map. The Map Segment 254 for AOI(0) is set to “A”.

The Map Segment Coordinates 253 are incremented in accordance with the following logic: If the Map Focus Logic(n) 252 is TRUE, then do not increment the Map Segment Coordinates 253. Unincremented Coordinates(n) 253 for AOI(n) 210 may be shown in the Truth Table, or display a blank. This does not affect the calculations. If the Map Focus Logic(n) 252 is FALSE then increment the Map Segment Coordinates 253 to the Map Coordinates values (Xn,Yn) 211.

Each time the Map Segment Coordinates 253 change, the Map Segment value is incremented by one letter, hence the five Map Segments 254.

To enhance the disclosure and teachings of the present invention, FIG. 14-1 and FIG. 14-2 contain the complete source code for the fully functioning Excel computer program that produced FIG. 13.

FIG. 15 shows the Map Segment Coordinates 253 displayed on Map A 111. Turning now to FIG. 15-1 there is a more detailed description of the Plotting Routine 185. The inputs to the Plotting Routine 185 are the Map Truth Table 108 from FIG. 13 and Map A 111 from FIG. 15. Setting the initial Area of Interest Occurrence 210 number (n) equal to zero, the logic of the Plotting Routine 185 is that if the Map Segments Coordinates 253 for a given Area of Interest Occurrence 210 number (n) is not blank THEN plot Coordinates 253 Xn,Yn on Map A 111. Then the Area Of Interest Occurrence 210 number (n) is incremented by one, and the process is repeated until Nmax elements have been evaluated for plotting.

With reference to FIG. 16 there is shown a non-limiting example of how the Linear Map Areas A,B,C,D and E can be readily determined and plotted once the Map Segment Coordinates 253 are known. In general if there are N Map Segment Coordinates 253, there are N−1 Map Segment Areas 254. In the non-limiting example shown in FIG. 16 there are six Map Segment Coordinates 253 and five Map Segment Area 254, A,B,C,D,E.

The Linear Map Area Definitions 112 shown in FIG. 16 uses the data from the Map Segment Coordinates Module 110 FIG. 15 to create defined rectangular map segments. In other embodiments of the invention, the Map Segment Areas may be other shapes. In this illustrative embodiment, the Map Segment Areas are calculated by “squaring off” each successive pair of Map Segment Coordinates, as shown in FIG. 16.

FIG. 16-1 is a flowchart of the Linear Map Segment Areas 112 Plotting Routine

FIG. 16-2 is a non-limiting numerical example showing the four corner X,Y Coordinates for each of the Linear Map Segment Areas. For example, Map Segment A 190, has Coordinates 178, 179, 180 and 181 for its four corners.

With reference to FIG. 17, the Non-Linear Map Area Definitions Module 114 receives the data from the Linear Map Area Definitions Module 112. In this non-limiting illustrative example, the Linear Map Area Definitions 114 are rectangles A, C and E.

Based on Control Parameters received from the User Input Interface Module 102, the Non-Linear Map Area Definitions Module 114, operates on the Linear Map Areas 112 in FIG. 16, to produce a mapping of the Original Linear Map Segment Areas A, C, E, 310 into the Non-Linear Map Segment Areas A*, B*, C* 311.

In a non-limiting exemplary embodiment displayed in FIG. 17, the mapping C□C* of Linear Area C into Non-Linear Area C* is accomplished by selecting, using exemplary devices such as touch screens or a mouse, Point 302 (coordinates X6,Y5) and dragging the pointer to Point 303 (coordinates XC*,YC*). This action defines the new Non-Linear Area C*. The mapping A□A* and the mapping E□E* are accomplished by the same process.

In yet another non-limiting exemplary embodiment, FIG. 17-1 discloses a method for the Autonomous Derivation of Non-Linear Map Areas 311 from Linear Map Areas 310. In this embodiment, the coordinates of Linear Map Areas 310 are modified in a series of sequential iterative optimizations to seek Non-Linear Map Areas 311 that have equal information densities. In this example, the Information Density of a proposed C* Non-Linear Map Area 316 would be defined as the [Number of AOI's in C*]/[Area of C*]. A set of final coordinates A*, B*, C* is determined when the Figure of Merit, which in this example is the standard deviation of the Information Densities for A*, B*, C* is less than a defined threshold or a maximum number of iterations has occurred.

In the foregoing non-limiting embodiment. The optimization search process could be based on searches over fixed increments, by monte-carlo simulation or by various guided search methodologies.

The two foregoing non-limiting exemplary embodiments for mapping from Linear Map Areas→Non-Linear Map Areas show two completely different methods for accomplishing a Linear to Non-Linear Map Transform. Accordingly, a person having ordinary skills in the art can readily see that the present invention is not limited in scope to any particular type of devices, methodologies, criteria, search process designs, Figures of Merit, or by rules for the Map Transform process, which may be of any type or design. Additionally, the scope of the invention is not limited by the devices, media or systems on which information is gathered, computed or transmitted

At this point, the Non-Linear Map Areas 311 A*,B*,C* exist as three rectangles, each with four Coordinates. FIG. 18 explains how the Non-Linear Map Areas 311 A*, B*, C* are populated with non-linear map data, for assembly into the final internal Non-Linear Map 116. At this point, the size and coordinates of A*,B*,C* are known but there is no actual non-linear map data within any of the non-linear rectangles.

In a non-limiting example, as shown in FIG. 18, the Internal Non-Linear Map Module 116 takes the Areas of Interest C 312 at its original scale, as in FIG. 17, and inserts it into the rectangle containing the Non-Linear Map Segment Area C* 316 in FIG. 17. The original Map Area C is expanded in proportion to the aspect ratio and size of C and C*. Other embodiments of the present invention could, by way of a non-limiting example include scaling, rotation or cropping of images.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for generating map views, comprising:
an import interface that receives a map area from a device;
an interest module that defines an interest metric that varies as a function of a location in the map area;
an AOI module that defines a first area to expand and a second area to expand in the map area as a function of the interest metric;
an expanded view module that defines a first set of dimensions of a first zoomed-in view of the first area to expand and a second set of dimensions of a second zoomed-in view of the second area to expand;
a map generator that generates an overall view of the map area and overlays the first zoomed-in view having the first set of dimensions and the second zoomed-in view having the second set of dimensions over the overall view on a display.

2. The system of claim 1, wherein the interest module defines the interest metric by presenting a list of potential metrics to a user interface configured to receive a selection of the interest metric from the list of potential metrics.

3. The system of claim 1, wherein the interest metric is selected from the group consisting of:
a turn in a route map;
a length of a non-turning segment in a route map;
a Richter scale measurement;
a temperature;
an elevation; and
an alert.

4. The system of claim 1, wherein the interest metric comprises a binary value that defines a measured value above a threshold value as true and the measured value below the threshold value as false.

5. The system of claim 1, wherein the AOI module is configured to present a representation of the interest metric in the map area to an output user interface and is configured to define the first area to expand and second area to expand by receiving a selection of the first area to expand and the second area to expand from an input user interface.

6. The system of claim 1, wherein the AOI module is configured to define a set of areas in the map area, wherein the first area to expand and the second area to expand are within the set of areas in the map area, and wherein the AOI module is configured to calculate a collective interest metric density for each area in the set of areas.

7. The system of claim 6, wherein the AOI module is configured to automatically select the first area to expand and the second area to expand from the set of areas as a function of their comparative collective interest metric density.

8. The system of claim 7, wherein the AOI module is configured to ensure that the first area to expand and the second area to expand are non-overlapping.

9. The system of claim 6, wherein the AOI module is configured to define each area in the set of areas as a rectangle drawn between two points in a route map.

10. The system of claim 6, wherein the AOI module is configured to resize at least one area of the set of areas to increase the collective interest metric density for the at least one area.

11. The system of claim 10, wherein the AOI module is configured to reiterate the resizing step until a standard deviation of an original collective interest metric density and a resized collective interest metric density falls below a threshold value.

12. The system of claim 1, wherein the expanded view module defines the first set of dimensions and the second set of dimensions by receiving a selection of the first set of dimensions and the second set of dimensions from a user interface.

13. The system of claim 1, wherein the expanded view module is configured to define the first set of dimensions as a function of a size of the map area.

14. The system of claim 1, wherein the expanded view module is configured to define the first set of dimensions as a rotated view of the first area to expand.

15. The system of claim 1, wherein the map generator is configured to overlay the first zoomed-in view over the first area to expand in the map area.

16. The system of claim 15, wherein the map generator is further configured to overlay a corner of the first zoomed-in view over a corresponding corner of the first area to expand in the map area.

17. The system of claim 1, wherein the map generator is configured to overlay the first zoomed-in view in a section of the map area that fails to contain an area to expand.

18. The system of claim 1, wherein the map generator is configured to ensure that the first zoomed-in view and the second zoomed in view fail to overlay one another.
